(19) United States
(12) Patent Application Publication
(10) Pub. No.: US 2005/0278280 A1
(43) Pub. Date: Dec. 15, 2005

(54) Self update mechanism for update module

(76) Inventors: Krasimir P. Semerdzhiev, Sofia (BG); Nikolai S. Dimitrov, Sofia (BG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/856,247

(22) Filed: May 28, 2004

(51) Int. Cl. G06F 7/00

(52) U.S. Cl. 707/1

(57) ABSTRACT

A system for updating files in a computer system. The update system may download files from a centralized database during a start up process for a computer system. The start up process may complete the loading of all services and applications to be provided by the computer system, then initiate an update process. The update system may close open files such as open archive files. The files may then be replaced by the downloaded files. This system allows for the update of the update module handling the file replacement without requiring the generation of scripts or code to be executed during a subsequent start up process to complete the update.

### BACKGROUND

1. Field of the Invention

The embodiments of the invention relate to software installation applications. Specifically, embodiments of the invention relate to an update mechanism to replace files of applications while they are executing.

2. Background

A cluster system is utilized to provide a set of services and resources to a set of client computers. The cluster system includes a collection of server nodes and other components that are arranged to cooperatively perform computer-implemented tasks, such as providing client computers with access to the set of services and resources. A cluster system may be used in an enterprise software environment to handle a number of tasks in parallel. A cluster system is scalable and has the flexibility to enable additional cluster elements to be incorporated within or added to the existing cluster elements.

Traditional client-server systems provided by a cluster system employ a two-tiered architecture. Applications executed on the client side of the two-tiered architecture are comprised of a monolithic set of program code including a graphical user interface component, presentation logic, business logic and a network interface that enables the client to communicate over a network with one or more servers in a clustered system that provide access to a set of services and resources.

The “business logic” component of the application represents the core of the application, i.e., the rules governing the underlying business process (or other functionality) provided by the application. The “presentation logic” describes the specific manner in which the results of the business logic are formatted for display on the user interface.

The limitations of the two-tiered architecture become apparent when employed within a large enterprise system. For example, installing and maintaining up-to-date client-side applications on a large number of different clients is a difficult task, even with the aid of automated administration tools. Moreover, a tight coupling of business logic, presentation logic and the user interface logic makes the client-side code very brittle. Changing the client-side user interface of such applications is extremely difficult without breaking the business logic, and vice versa. This problem is aggravated by the fact that, in a dynamic enterprise environment, the business logic may be changed frequently in response to changing business rules. Accordingly, the two-tiered architecture is an inefficient solution for enterprise systems.

In response to limitations associated with the two-tiered client-server architecture, a multi-tiered architecture has been developed. In the multi-tiered system, the presentation logic, business logic and set of services and resources are logically separated from the user interface of the application. These layers are moved off of the client to one or more dedicated servers on the network. For example, the presentation logic, the business logic, and the database may each be maintained on separate servers. In fact, depending on the size of the enterprise, each individual logical layer may be spread across multiple dedicated servers.

This division of logical components provides a more flexible and scalable architecture compared to that provided by the two-tier model. For example, the separation ensures that all clients share a single implementation of business logic. If business rules change, changing the current implementation of business logic to a new version may not require updating any client-side program code. In addition, presentation logic may be provided which generates code for a variety of different user interfaces, which may be standard browsers such as Internet Explorer® or Netscape Navigator®.

A multi-tiered architecture may be implemented using a variety of different application technologies at each of the layers of the multi-tier architecture, including those based on the Java 2 Enterprise Edition Specification created by Sun Microsystems, Santa Clara, Calif. (“J2EE”), the Microsoft .NET Framework created by Microsoft Corporation of Redmond, Wash. (“.Net”) and/or the Advanced Business Application Programming (“ABAP”) standard developed by SAP A G. For example, in a J2EE environment, the business layer, which handles the core business logic of the application, is comprised of Enterprise Java Bean (“EJB”) components with support for EJB containers. Within a J2EE environment, the presentation layer is responsible for generating servlets and Java Server Pages (“JSP”) interpretable by different types of browsers at the user interface layer.

### SUMMARY

Embodiments include a system for updating files in a computing system. The update system may download files from a centralized database during a start up process for a computing system. The start up process may complete the loading of all services and applications to be provided by the computing system, then initiate an update process. The update system may close open files such as open archive or binary files. The files may then be replaced by the downloaded files. This system allows for the update of the update module handling the file replacement without requiring the generation of scripts or code to be executed during a subsequent start up process to complete the update.

### BRIEF DESCRIPTION OF THE DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of one embodiment of an update system.

FIG. 2 is a flowchart of one embodiment of the update system.

FIG. 3 is a diagram of one embodiment of a computer system running the update system.

FIG. 4 is a diagram of one embodiment of a cluster system running the update system.

### DETAILED DESCRIPTION

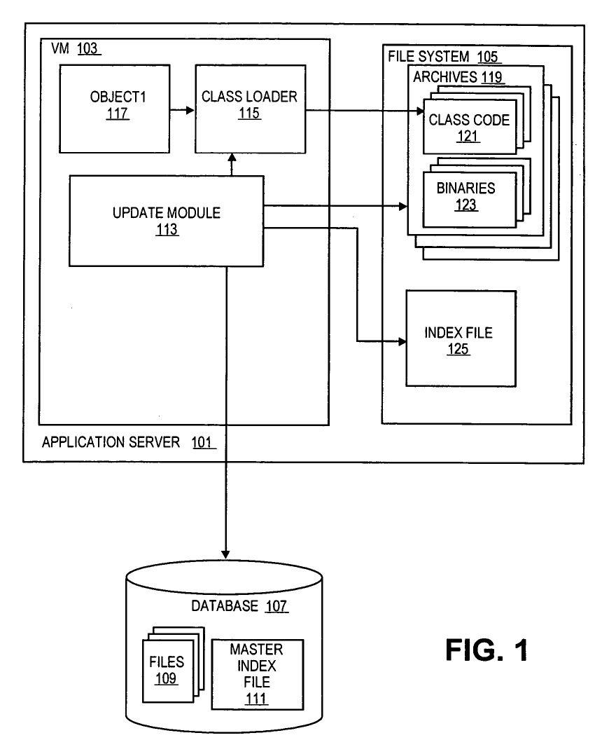

FIG. 1 is a diagram of one embodiment of a computer system utilizing an update system. In one embodiment, the update system operates on a local machine to update the files of applications and services provided by the local machine. In one embodiment, the local machine is an application server 101. Application server 101 may provide access to services and resources for a set of clients. Clients may be remote computers, a local application, and similar programs local to the server or remote from the server. In one embodiment, the services and resources provided by application server 101 may be applications and services related to enterprise software and resources.

In one embodiment, the local machine may have a file system 105. File system 105 may be used to store files related to the applications and services provided by application server 101. In one embodiment, files stored by file system 105 may include archive files 119. An archive file is a file that may contain multiple files in a compressed or encrypted format. In one embodiment, an archive file may be a java archive file (JAR). A java archive file may be used to store code in class files to be used to instantiated objects in a java virtual machine (JVM) 103. In another embodiment, other types of archive files may be supported by the update system including zip files, software deployment archives, and similar archive files. In one embodiment, archive file 119 may store other types of files including binary files, data, text files and similar file types.

In one embodiment, file system 105 may store any type of file including archive files, binary files, text files, database files and similar file formats. In one embodiment, an index file 125 may be stored in file system 105. In one embodiment, index file 125 may track the status of directories and files in file system 105 or a portion of file system 105 based on the size of the contents, last modification, names of files in the directories or similar properties. These properties may be quantified or hashed to produce a value or set of values for the file system 105 and for directories in file system 105. Index file 125 may be used as a reference to determine which files in file system 105 have been changed, removed or added or which files are designated to be changed, removed or added.

In one embodiment, the local machine may execute applications and services using a virtual machine 103 environment. Virtual machine 103 may be a java virtual machine including a java virtual machine based on the Java 2 Enterprise Edition Specification (“J2EE”) created by Sun Microsystems, Inc., Santa Clara, Calif., or similar virtual machine. Virtual machine 103 may support any number of applications and services including an update module 113. Applications, services and similar programs and modules may be executed by the local machine in the form of objects 117 or sets of objects.

In one embodiment, applications and services in the form of objects may be loaded by a class loader 115, set of class loaders or similar loading utilities. During system start up, virtual machine 103 may invoke class loader 115 or a set of class loaders to open files and archives 119 to retrieve the code of the applications and services to be executed by virtual machine 103. Class loader 115 and virtual machine 103 may leave the files and archives in an open state after retrieving the data and instructions needed during systems start up. An operating system may prevent files in an open state from being moved, opened or deleted by other applications, utilities or programs. In another embodiment, applications and services may be loaded from compiled binary files, or code files to be executed or interpreted. A loader module or program may be used to retrieve data and instructions from the files. This loader program may open the file to read the data and instructions and leave the file in an open state during execution of the application.

In one embodiment, update module 113 may be in communication with a database 107. Database 107 may be a local database or a remote database. Database 107 may be stored on a fixed disk, removable media or similar storage media. Database 107 may store a set of files 109 to be deployed to the local machine and file system 105. Update module 113 may initiate the transfer of files 109 to a temporary location on the local machine or in file system 105. Update module 113 communicates with a loader program, class loader 115 or virtual machine 103 to release each of the files held in an open state. In one embodiment, update module 113 invokes a release command provided by the loader to release a file or set of files. In one embodiment, update module 113 releases the files that are to be modified or replaced. When the files have been released update module 113 may move the downloaded files to replace the local files or modify the local files. The old files may be deleted or overwritten.

In one embodiment, database 107 stores a master index file 111. Master index file 111 may track a set of files 109, stored in database 107 in any form in the same manner as index file 125 tracks a set of files stored in file system 105. Master index file 111 may be altered when a new set of files is to be deployed, a set of files modified, or a set of files added to file system 105. Master index file 111 may be altered to reflect the desired status of file system 105 after the deployment or removal of designated files. In one embodiment, update module 113 compares master index file 111 to local index file 125 to determine which files in database 107 to retrieve and where to place each file or modify each file in file system 105. After an update is complete, index file 125 may be replaced or updated to reflect the new state of file system 105. In one embodiment, a copy of master index file 111 may replace index file 125.

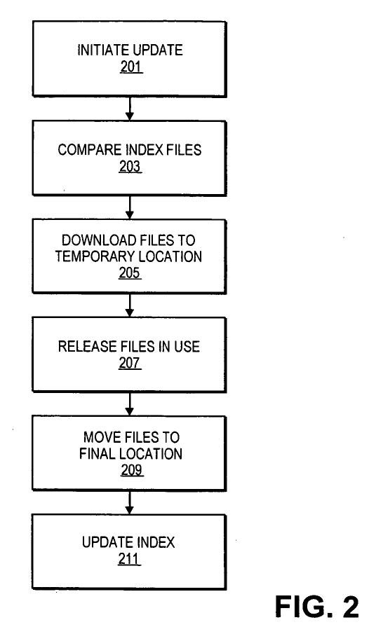

FIG. 2 is a flowchart of one embodiment of a process for updating a computing system. In one embodiment, during a start up sequence of a local machine, an update module or similar application may be invoked to determine if the local machine is to be updated by replacing, modifying or removing files on the local machine (block 201). The update module may be invoked after the other system components such as services and applications have been instantiated. The update module may be an object or set of objects instantiated by a virtual machine. In another embodiment, the update module may be invoked at any time during the operations of the local machine.

In one embodiment, the update module may read a local index file that tracks the status of a local file directory or a portion of a local file directory. The local index file may catalogue the files in the file system and unique binary-based hashes of the files present in the file system or similar information about the files in the file system. The local index file may be compared to a master or remote file index that indicates the files and file hashes or similar indicators to be present in the local file directory after an update of the local file system (block 203). The comparison of the master index file and the local index file allows the update module to determine which files in the local index file do not match the files of the master file index, which files are new and which files are missing. In one embodiment, the update module may determine the names and locations of each file to be added, modified or deleted by a comparison of the master index file with the local index file. In another embodiment, the local index file and master index file may be located at a remote location, in a central database or in any location accessible by the update module. In a further embodiment, any system may be used to designate files to be added, modified or deleted. A master file index may be retrieved in its entirety or only a part of the master file index may be utilized by the update module.

In one embodiment, after the file indexes have been compared or the files to be modified, added or deleted have been identified the update module may download the needed files from the database (block 205). Files to be downloaded may be packaged in an archive file such as a software deployment archive, java archive, zip file or similar archive file. Files may be stored in a database. The database may be a relational database. Location of needed files in a database or file system may be determined by examining the entry in the master index file related to the file to be retrieved. The location of files indicated as needed by the file comparison may be retrieved from the database by a search query or similar method. The files retrieved may be stored in a temporary location on the local machine. The temporary location may be a predetermined file directory or similar location.

In one embodiment, after each of the files to be modified or replaced is identified, the update module may request that the original file that is to be modified, replaced or removed in the local file system be released (block 207). In one embodiment, the files may be in an open state and held by a virtual machine or loader module. For example, in a J2EE environment, some class files and java archive files may be held in an open state by a java virtual machine or a class loader. The update module may invoke a ‘release’ operation, method or similar program for each file that needs to be replaced or modified. In another embodiment, the update module may request a release for all open files and archives. A release method or program may be provided by a loader or class loader module or object. In further embodiment, the release of files and archives may be done simultaneously with the download of new files or before the download of new files. Open files may not be modified or deleted. Invoking a release program that closes these files allows for the update of the overall system and its services and resources without requiring that the related applications and resources be closed or exited including the update module itself.

In one embodiment, after all files or the files to be modified or replaced have been closed or released, the update module may move files from their temporary download locations to the intended location in the local file system (block 209). Old files to be replaced may be deleted or overwritten. In one embodiment, files may be directly downloaded to their intended location if old files have been released and/or deleted or if the downloaded file is new. Old files to be removed may be deleted after they are released. In one embodiment, after the files have been copied to the new location the temporary file copies may be deleted. The temporary file directory may also be deleted. The update module may verify the contents of the new files in their final location. Any files that are not correctly installed may be retrieved again from the database and redeployed.

In one embodiment, after the files are modified, removed or added, the update module may modify the local index file to reflect the new status of the file system (block 211). In another embodiment, another application may handle the management of the index file and may be invoked by the update module after it has finished with its file transfer. The local index file may be regenerated in total or may be modified to reflect the changes made by the update module.

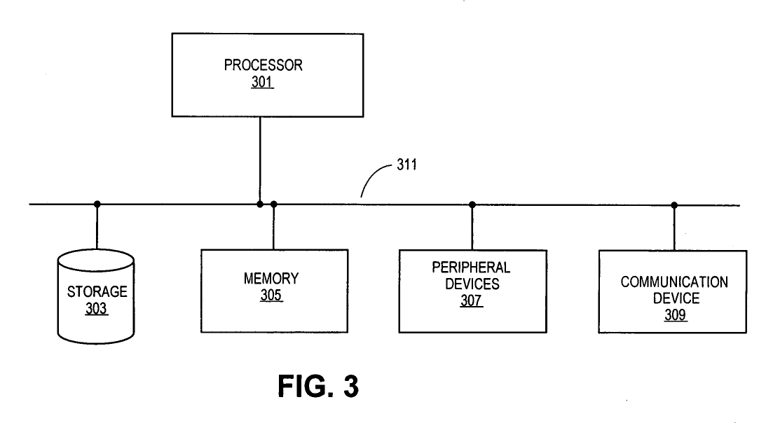

FIG. 3 is a block diagram of an exemplary computer system for executing the update system. In one embodiment, the computer system may include a processor 301 or set of processors to execute the update module, virtual machine, applications, services and similar programs. The processor may be a general purpose processor, application specific integrated circuit (ASIC) or similar processor. Processor 301 may be in communication via a bus 311 or similar communication medium with a memory device 305. Memory device 305 may be a system memory device or set of devices such as double data rate (DDR) memory modules, synchronized dynamic random access memory (SDRAM) memory modules, flash memory modules, or similar memory devices. Memory device 305 may be utilized by processor 301 as a working memory to execute the virtual machine, applications, the update module and similar programs.

In one embodiment, the computer system may include a storage device 303. Storage device 303 may be a magnetic disk, optical storage medium, flash memory, or similar storage device. Storage device 303 may be utilized to store files, including a file system, program files, including update module files, temporary files, index files and similar files and data structures. The computer system may also include a set of peripheral devices 307. Peripheral devices 307 may include input devices, sound system devices, graphics devices, display devices, auxiliary storage devices, or similar devices or systems utilized with a computer system.

In one embodiment, the computer system may include a communication device 309. Communication device 309 may be a networking device to allow the computer system and applications, services and similar programs to communicate with other computers, applications, services and similar programs. In one embodiment, communication device 309 may be utilized to communicate with a remote database and retrieve or receive files from the database.

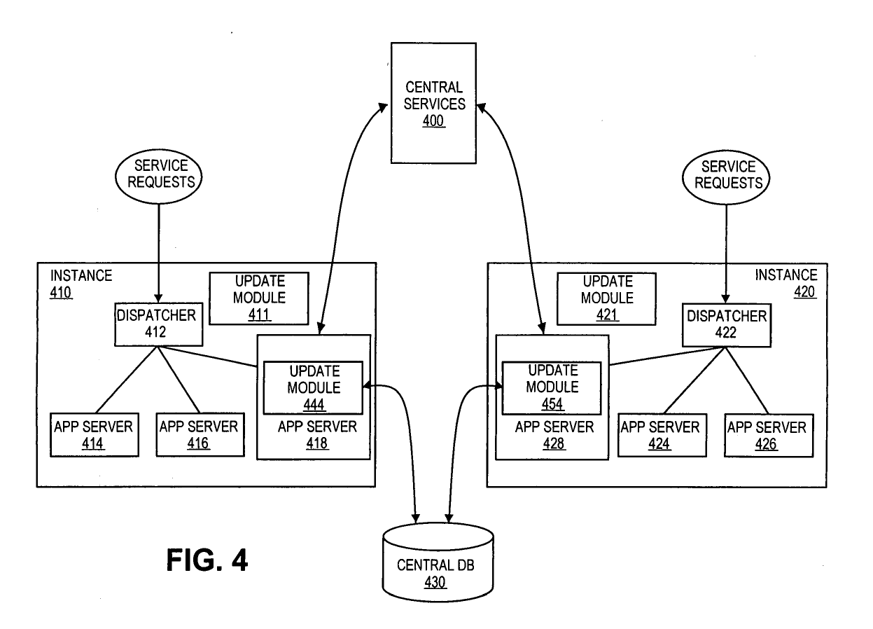

FIG. 4 is one embodiment of a system that includes an update system. In one embodiment, the system architecture may include a central services instance 400 and a plurality of application server instances 410, 420. In one embodiment, the application servers are organized into groups referred to as “instances.” Each instance includes a group of redundant application servers and a dispatcher for distributing service requests to each of the application servers. A group of instances may be organized as a “cluster.” The application server instances, 410 and 420, may each include a group of application servers 414, 416, 418 and 424, 426, 428, respectively, and a dispatcher, 412, 422, respectively.

In one embodiment, the central services instance 400 may include services shared amongst instances 410, 420, and their constituent parts, as well as other cluster resources such as database 430. These shared services may include a locking service, a messaging service and similar services. The combination of the application server instances 410, 420 and the central services instance 400 may be the primary constituents of the cluster system. Although the following description will focus primarily on instance 410 for the purpose of explanation, the same principles and concepts apply to other instances such as instance 420.

In one embodiment, the application servers 414, 416, 418 within instance 410 may provide business and/or presentation logic for the network applications supported by the cluster system. Each of application servers 414, 416 and 418 within a particular instance 410 may be configured with a redundant set of application logic and associated data. In one embodiment, dispatcher 412 distributes service requests from clients to one or more of application servers 414, 416 and 418 based on the load on each of the servers.

In one embodiment, application servers 414, 416 and 418 may be Java 2 Enterprise Edition (“J2EE”) application servers which support Enterprise Java Bean (“EJB”) components and EJB containers (at the business layer) and Servlets and Java Server Pages (“JSP”) (at the presentation layer). In another embodiment, the cluster system, applications servers and update module may be implemented in the context of various other software platforms including, by way of example, Microsoft .NET platforms and/or the Advanced Business Application Programming (“ABAP”) platforms developed by SAP AG.

In one embodiment, each application server may include an update module 444, 454, or similar program. In one embodiment, update modules 444 and 454 may communicate with central database 430 to update each application server in accordance with a configuration of services, applications and files deployed in central database 430. In another embodiment, the update module may be a standalone program 421, 411 handling a complete instance 410, 420. In one embodiment, central database 430 may contain files and data to be deployed to an array of different platforms.

In one embodiment, update modules 444 and 454 may utilize only the files, services and applications that are designated for deployment on the platform of the application server associated with update modules 444 and 454. For example, some cluster or application servers may operate on a Windows platform, while other clusters or application servers may operate on a Linux platform. The database may include file descriptors or similar structure to identify which files are to be distributed to each platform or to platforms with specific properties (e.g., 64-bit or 32-bit platforms). In one embodiment, the database may include separate file indexes for separate platforms or configurations to be utilized by the update module to determine the appropriate set of files to download and install.

In one embodiment, an update module may operate remotely from a target machine to be updated. The update module may have access to the index file on the target machine or maintain it local to the update module. The update module moves files to be updated from the database to the target machine.

In one embodiment, the update system may be implemented in software and stored or transmitted in a machine-readable medium. As used herein, a machine-readable medium is a medium that can store or transmit data such as a fixed disk, physical disk, optical disk, CDROM, DVD, floppy disk, magnetic disk, wireless device, infrared device, and similar storage and transmission technologies.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. An system comprising:
a first index to track a first set of files;
a second index to track a second set of files;
a database containing a third set of files; and
a first update module in communication with the first and second index and database to initiate a comparison of the first and second index and initiate a retrieval of the third set of files, the first update module causing a fourth set of files to be replaced by the third set of files while data from the fourth set of files is in use by a first virtual machine.

2. The system of claim 1, further comprising:
a remote machine to store the first index.

3. The system of claim 1, further comprising:
a local machine to store the second index that tracks a set of files on the local machine.

4. The system of claim 1, further comprises:
a remote machine housing the database which is one of a relational database and object database.

5. The system of claim 1, further comprising:
a second update module on a remote machine to initiate a comparison of the first index with a third index and initiate a retrieval of a fifth set of files, the second update module causing a sixth set of files to be replaced by the fourth set of files while data from the fourth set of file is in use by a java virtual machine.

6. A method comprising:
accessing a database to determine a first set of files to update on a target system;
retrieving a second set of files from the database;
closing a third set of files on the target system; and
replacing the third set of files with the second set of files while data from the third set of files is in use by an application.

7. The method of claim 6, further comprising:
comparing a first index corresponding to a file structure of the target system to a second index in the database.

8. The method of claim 6, wherein the application is a virtual machine.

9. The method of claim 6, wherein accessing the database comprises:
communicating with a remote machine on which the database resides.

10. The method of claim 6, wherein retrieving comprises:
transferring one of a java archive and binary file containing the second set of files from the database to a local machine.

11. A machine readable medium having stored therein a set of instructions which when executed cause a machine to perform a set of operations comprising:
accessing a database to determine a component to update on a target system;
retrieving a component file from the database;
closing an open component file on the target system; and
replacing the component file on the target system with the component file from the database while an instance of the component is executing.

12. The machine readable medium of claim 11, having further instructions stored therein which when executed cause a machine to perform a set of operations further comprising:
comparing a first index corresponding to a file structure of the target system to a second index in the database to determine the component to update.

13. The machine readable medium of claim 11, wherein accessing comprises:
querying a relational database.

14. The machine readable medium of claim 12, wherein comparing comprises:
accessing the first index located in the database.

15. The machine readable medium of claim 11, wherein retrieving comprises transferring the component stored in the form of a java archive file to a local machine.

16. A system comprising:
means for accessing a database to determine a component to update on a target system;
means for retrieving a component file from the database;
means for closing an open component file on the target system; and
means for replacing the component file on the target system with the component file from the database while an instance of the component is executing.

17. The system of claim 16, further comprising:
means for comparing a first index corresponding to a file structure of the target system to a second index in the database to efficiently determine the component to update.

18. The system of claim 16, further comprising:
means for releasing files used by a currently running application.

19. The system of claim 16, further comprising:
means for storing a component in a database, the database being a relational database.

20. The system of claim 17, further comprising:
means for retrieving the first index located in the database.

21. A system comprising:
a plurality of servers, each server having an executing component;
a database in communication with the plurality of servers, the database containing a set of component files to be updated to the plurality of servers; and
an update application in communication with the database and plurality of servers, the update module to transfer the set of components to the plurality of servers, the update module to replace a component file corresponding to an executing component without terminating the executing component.

22. The system of claim 21, further comprising:
a dispatcher module in communication with the plurality of servers to distribute a load between the plurality of servers.

23. The system of claim 21, wherein each of the plurality of servers is an application server.

24. The system of claim 21, wherein the executing component is a java application.
